(19) United States
(12) Patent Application Publication
(10) Pub. No.: US 2012/0079910 A1
(43) Pub. Date: Apr. 5, 2012

(54) HANDLEBAR/STEM ATTACHMENT INTERFACE WITH MINIMAL FRONTAL AREA

(76) Inventors: Kristopher T. Wehage, Seattle, WA (US); Ronald J. Correa, Seattle, WA (US)

(21) Appl. No.: 12/895,703

(22) Filed: Sep. 30, 2010

(51) Int. Cl. B62K 21/12; B62K 21/18

(52) U.S. Cl. 74/551.1

(57) ABSTRACT

A handlebar/stem attachment interface with minimal frontal area comprises a handlebar body and a stem between which is disposed a threaded element to screw or unscrew the stem. By such arrangements, it is convenient for the user to replace the handlebar as desired, and the smooth even configuration of the handlebar body can further reduce the drag coefficient of the bicycle while increasing the riding rate.

### BACKGROUND OF THE INVENTION

1. Field of the Invention

The present invention relates to a bicycle, and more particularly to a handlebar/stem attachment interface with minimal frontal area.

2. Description of the Prior Art

Bicycling is a popular means of recreation, fitness and competition. There are three main sources of drag which a cyclist must overcome: friction, gravity, and aerodynamic drag. Since aerodynamic drag increases with the speed of the cyclist squared, aerodynamic drag becomes an increasingly important concern at higher speeds, especially for competitive cycling. Aerodynamic drag is related to the shape of the vehicle and the frontal area. Thus, it is desirable to reduce the frontal area of the bicycle and all components to give the bicycle and rider the greatest possible aerodynamic advantage.

Take the bicycle handlebar as an example, a professional bicycle racer may have to use different handlebars according to different racing rules, or may need to adjust the fit of their bicycle through the course of the racing season. More importantly, since the bicycle handlebar is the upfront component of a bicycle, the configuration of the bicycle handlebar will largely affect the drag of the bicycle. As shown in FIG. 10, a conventional stem 80 for a bicycle handlebar is functionally designed without consideration of the aerodynamic drag, so that it might produce a larger aerodynamic drag during the riding process, seriously affecting the professional bicycle racer.

In view of these considerations, the inventor of the present invention has developed a handlebar/stem attachment interface with minimal frontal area which facilitates the replacement of the handlebar and reduces the drag coefficient of the bicycle.

### SUMMARY OF THE INVENTION

The primary objective of the present invention is to provide a handlebar/stem attachment interface with minimal frontal area which facilitates the replacement of the handlebar body and reduces the drag coefficient of the bicycle.

To achieve the above objective, a handlebar/stem attachment interface with minimal frontal area in accordance with the present invention comprises a handlebar body, a threaded element and a stem.

The handlebar body includes a central portion and two arms, the two arms have first ends thereof connected at both sides of the central portion, each of the two arms is connected to an extension extending forwards adjacent to the central portion. The central portion is formed with an assembling hole and tapered.

The threaded element includes a keyed hole and is further formed with external threads on an outer surface of a first end thereof. The threaded element is inserted in the assembling hole of the handlebar body, and the first end of the threaded element is located in a direction opposite a tapered direction of the central portion.

The stem includes a screwing end and a connecting end. The screwing end includes an inner threaded hole. The connecting end includes a through hole for engagement with a steerer tube of a front fork. The stem further includes an operating through hole penetrating the screwing end. The stem is screwed on the threaded element by inserting the screwing end in the assembling hole of the handlebar body.

With a single threaded element between the stem and the handlebar body, the user can easily replace the handlebar body, thus achieving the objective of facilitating replacement of the handlebar body, and further, the integrated streamlined appearance of the handlebar body reduces the drag coefficient of the bicycle.

### BRIEF DESCRIPTION OF THE DRAWINGS

FIG. 1 is an exploded view of a handlebar/stem attachment interface with minimal frontal area in accordance with a first embodiment of the present invention;

FIG. 2 is an assembly view of the handlebar/stem attachment interface with minimal frontal area in accordance with the first embodiment of the present invention;

FIG. 3 is a cross-sectional view of the handlebar/stem attachment interface with minimal frontal area in accordance with the first embodiment of the present invention;

FIG. 4 is an operational cross-sectional view of the handlebar/stem attachment interface with minimal frontal area in accordance with the first embodiment of the present invention;

FIG. 5 is a perspective view showing that the handlebar/stem attachment interface with minimal frontal area in accordance with the present invention is installed on a bicycle;

FIG. 6 is an exploded view of a handlebar/stem attachment interface with minimal frontal area in accordance with a second embodiment of the present invention;

FIG. 7 is an assembly view of the handlebar/stem attachment interface with minimal frontal area of FIG. 6 in accordance with the present invention;

FIG. 8 is a cross-sectional view of the handlebar/stem attachment interface with minimal frontal area of FIG. 6 in accordance with the present invention;

FIG. 9 is an operational cross-sectional view of the handlebar/stem attachment interface with minimal frontal area of FIG. 6 in accordance with the present invention; and

FIG. 10 is a perspective view of a conventional stem for a bicycle handlebar.

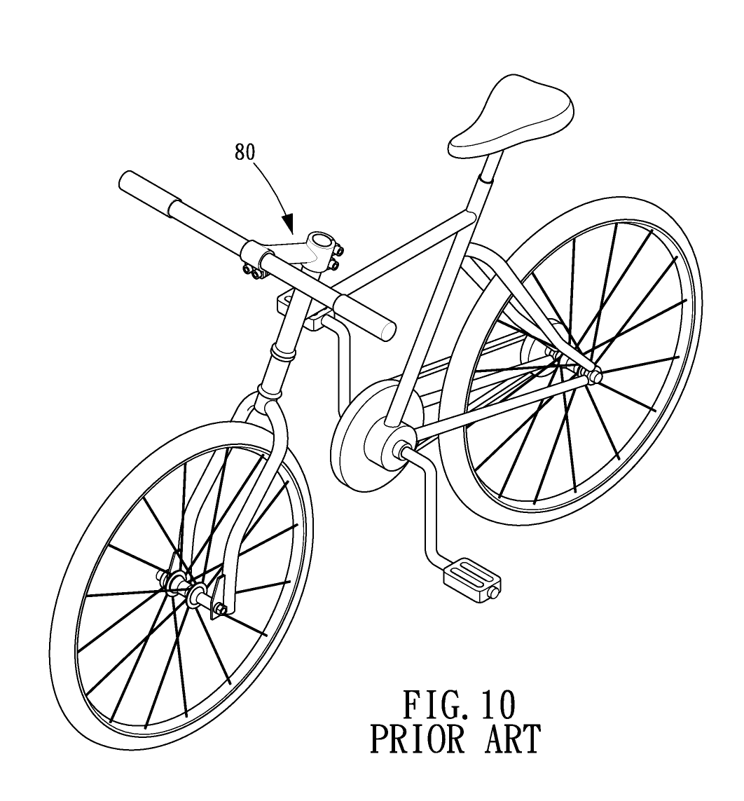

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

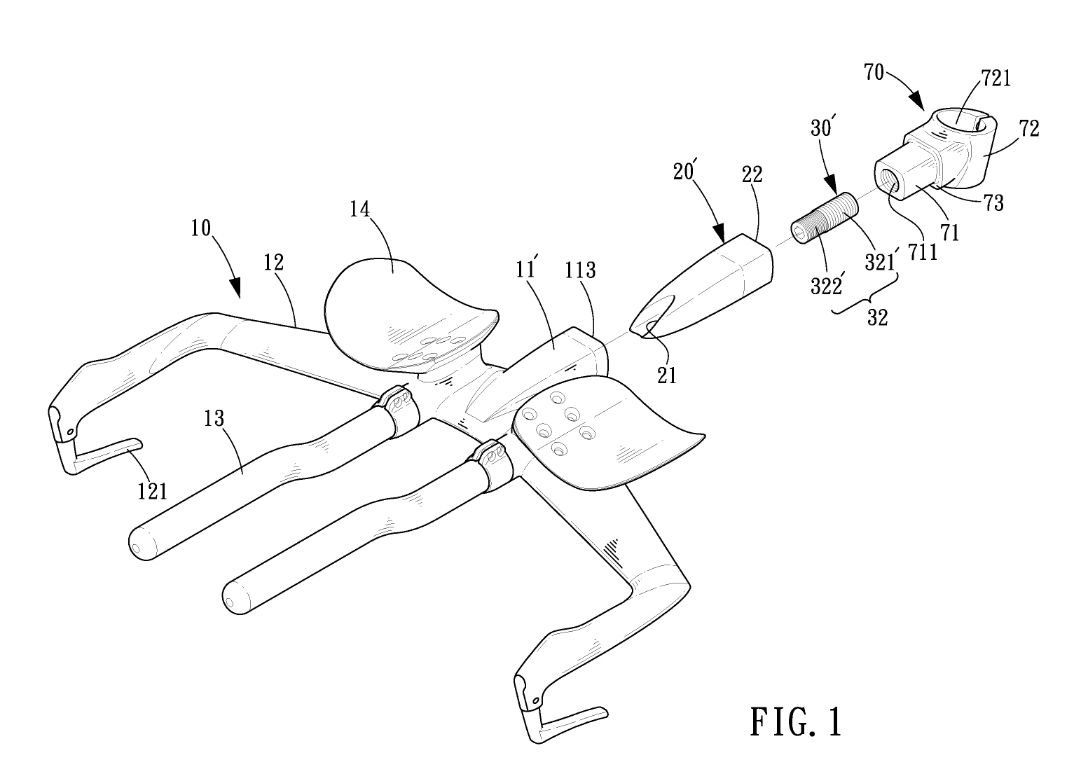

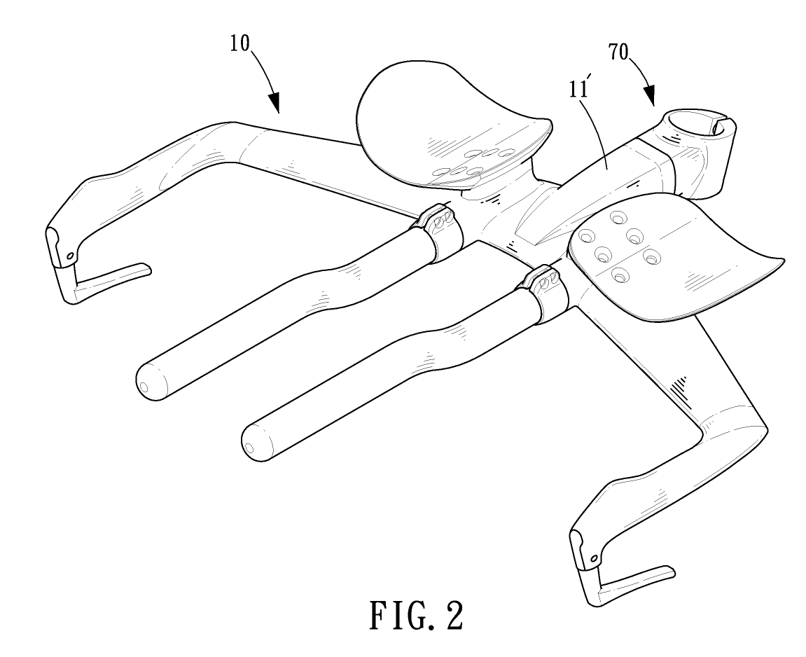

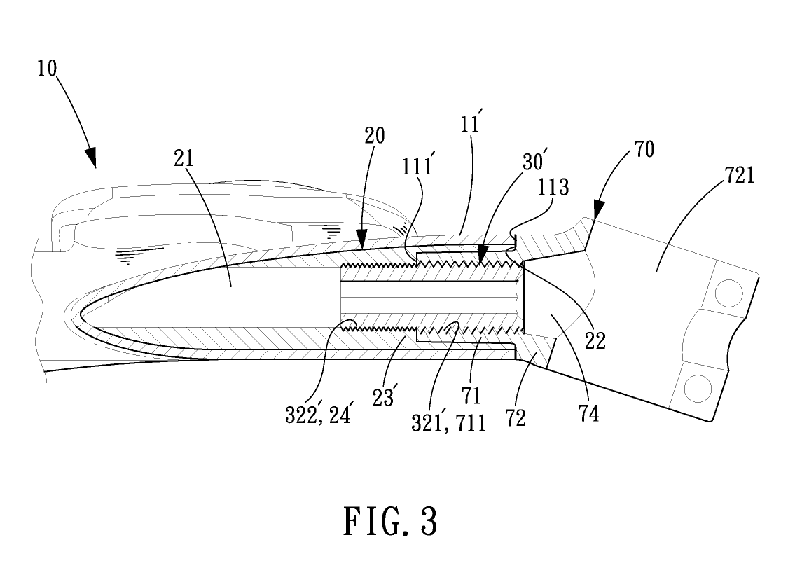

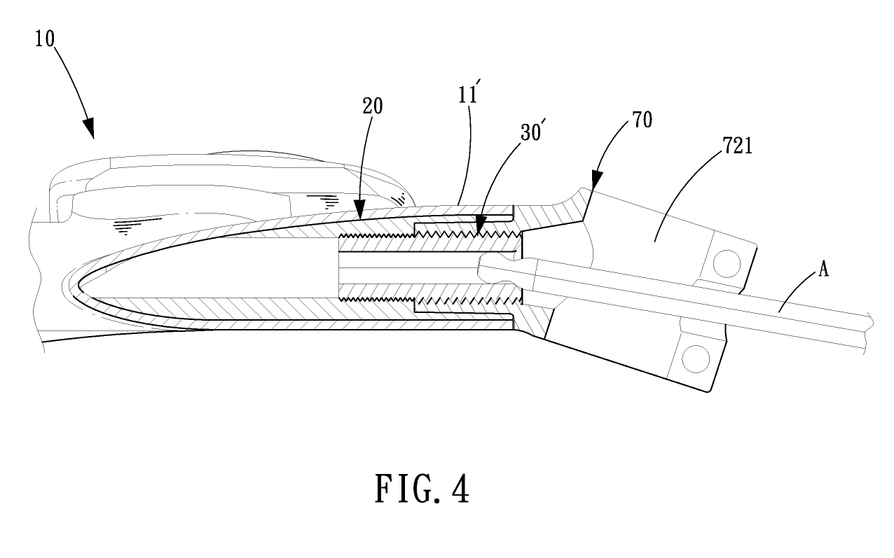

Referring to FIGS. 1-5, a handlebar/stem attachment interface with minimal frontal area in accordance with a first embodiment of the present invention comprises a handlebar body 10, an insert 20′, a stem 70, and a threaded element 30′.

The handlebar body 10 includes a central portion 11′ and two arms 12. The two arms 12 have first ends connected at both sides of the central portion 11′. Two brake levers 121 are provided at two second ends of the two arms 12, respectively. Each of the two arms 12 is connected to an extension 13 extending forwards adjacent to the central portion 11′, and each of the two arms 12 is further provided with an abutting seat 14 in alignment with the extension 13. The central portion 11′ is formed with an assembling hole 111′ penetrating the handlebar body 10 along an extending direction of the extensions 13. The assembling hole 111′ includes a second opening 113 open in a direction opposite the extending direction of the extensions 13. The handlebar body 10 is made of carbon fiber, and the central portion 11′ is tapered toward the extensions 13.

The insert 20′ is hollow and shaped correspondingly to the assembling hole 111′. The insert 20′ includes a first opening 21 and a second opening 22 in both ends thereof. The insert 20′ is further formed on an inner surface thereof with an abutting flange 23 between the first opening 21 and a second opening 22. The insert 20′ is inserted in the assembling hole 111′ of the central portion 11′ of the handlebar body 10 in such a manner that the second opening 22 of the insert 20′ is in communication with the second opening 113 of the central portion 11′. The insert 20 is made of aluminum. The insert 20′ is formed with an inner threaded hole 24′ extending from the abutting flange 23 toward a direction opposite the second opening 22.

The stem 70 includes a screwing end 71 and a connecting end 72 that are arranged in a stepped manner. Between the screwing end 71 and the connecting end 72 is formed an end surface 73. The screwing end 71 is in the form of a rectangular cylinder and includes an inner threaded hole 711. The connecting end 72 includes a through hole 721 for engagement with a steerer tube of a front fork. The stem 70 further includes an operating through hole 74 penetrating the screwing end 71. The stem 70 is inserted in the insert 20 in the assembling hole 111′ of the handlebar body 10 by inserting the screwing end 71 from the second opening 22 of the insert 20.

The threaded element 30′ includes a keyed hole 31 allowing the engagement of a wrench. The threaded element 30′ is further formed with external threads 32 on an outer surface thereof. The threaded element 30′ consists of a first segment and a second segment that are connected to each other, and an outer diameter of the first segment is bigger than that of the second segment. The first and the second segments of the threaded element 30′ include a first outer threaded portion 321′ and a second outer threaded portion 322′, respectively. The first outer threaded portion 321′ and the second outer threaded portion 322′ of the threaded element 30′ are screwed with the inner threaded hole 711 of the stem 70 and the inner threaded hole 24′ of the insert 20, respectively. A thread pitch of the first outer threaded portion 321′ is greater than that of the second outer threaded portion 322′. The threaded element 30′ is inserted through the second opening 22 of the insert 20′ from the operating hole 74 of the stem 7 in such a manner that the second threaded portion 322′ is screwed in the inner threaded hole 24′ of the insert 20′ while the first outer threaded portion 321′ is screwed in the inner treaded hole 711 of the stem 70.

The aforementioned is the summary of the positional and structural relationship of the respective components of the first embodiment in accordance with the present invention.

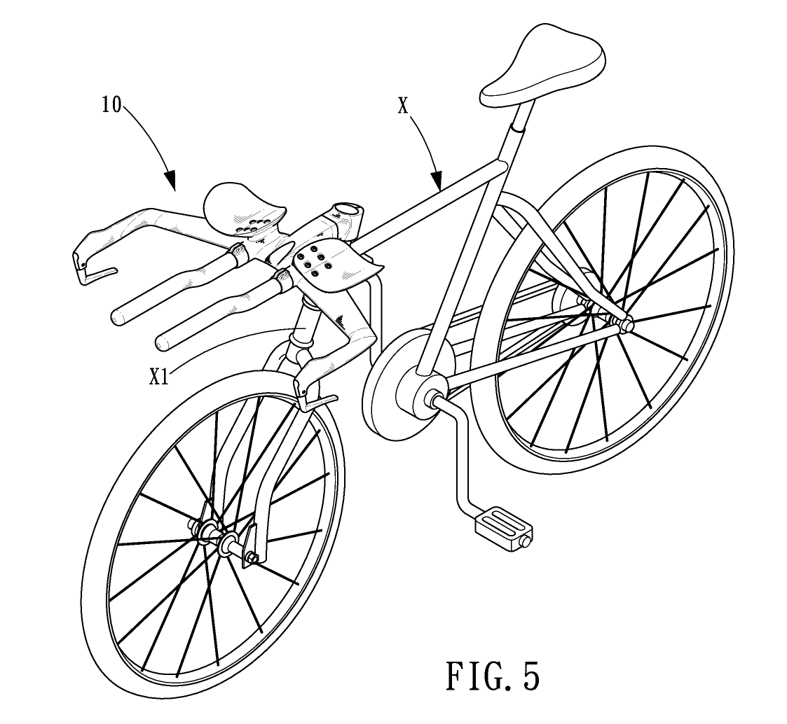

As shown in FIG. 5, the stem 70 is bonded to the steerer tube X1 of the front fork of the bicycle X. When in use, since the threaded element 30′ consists of the first segment and the second segment which include the first outer threaded portion 321′ and the second outer threaded portion 322′, respectively, and the first outer threaded portion 321′ and the second outer threaded portion 322′ are allowed to be screwed with the inner threaded hole 711 of the stem 70 and the inner threaded hole 24′ of the insert 20′, when being rotated, the threaded element 30′ will be screwed with both the stem 70 and the insert 20′, improving the convenience in operation.

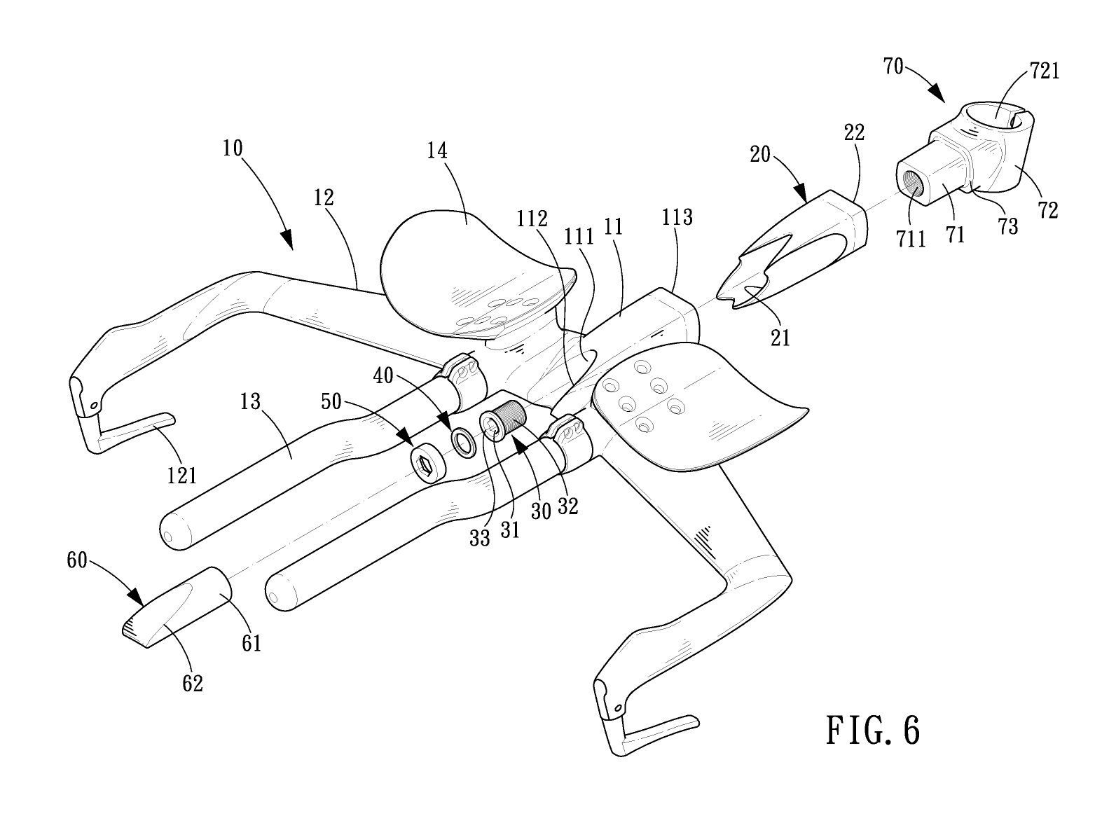

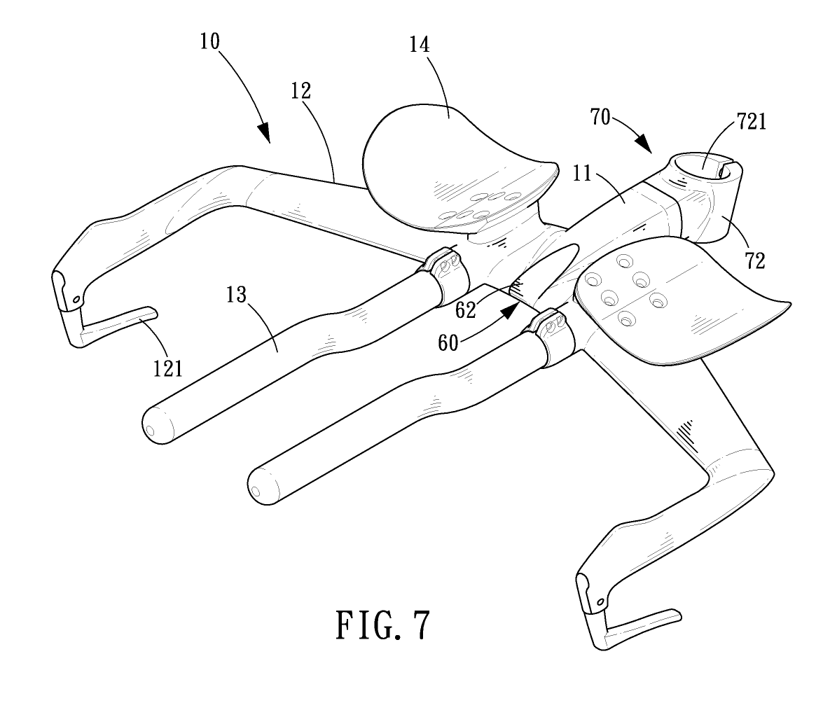

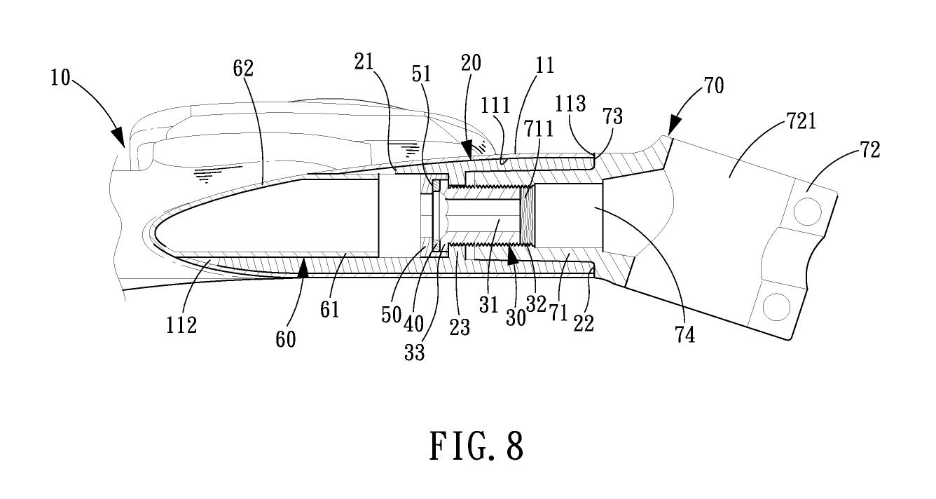

Referring to FIGS. 6-9, a handlebar/stem attachment interface in accordance with a second embodiment of the present invention comprises a handlebar body 10, an insert 20, a threaded element 30, a first extracting cap 40, a second extracting cap 50, a plug 60, and a stem 70.

The handlebar body 10 includes a central portion 11 and two arms 12. The two arms 12 have first ends connected at both sides of the central portion 11. Two brake levers 121 are provided at two second ends of the two arms 12, respectively. Each of the two arms 12 is connected to an extension 13 extending forwards adjacent to the central portion 11, and each of the two arms 12 is further provided with an abutting seat 14 in alignment with the extension 13. The central portion 11 is formed with an assembling hole 111 penetrating the handlebar body 10 along an extending direction of the extensions 13. The assembling hole 111 includes a first opening 112 open in the extending direction of the extensions 13, and a second opening 113 open in a direction opposite the extending direction of the extensions 13. The handlebar body 10 is made of carbon fiber, and the central portion 11 is tapered toward the extensions 13.

The insert 20 is hollow and shaped correspondingly to the assembling hole 111. The insert 20 includes a first opening 21 and a second opening 22 in both ends thereof. The insert 20 is further formed on an inner surface thereof with an abutting flange 23 between the first opening 21 and a second opening 22. The insert 20 is inserted in the assembling hole 111 of the central portion 11 of the handlebar body 10 in such a manner that the first opening 21 of the insert 20 is in communication with the first opening 112 of the central portion 11 while the second opening 22 of the insert 20 is in communication with the second opening 113 of the central portion 11. The insert 20 is made of aluminum.

The threaded element 30 includes a keyed hole 31 allowing the engagement of a wrench. The threaded element 30 is further formed with external threads 32 on an outer surface of a first end thereof, and a second end of the threaded element 30 is formed with an outwards-extended flange 33. The threaded element 30 is inserted into the insert 20 in the assembling hole 111 of the handlebar body 10 from the first opening 112 of the central portion 11 in such a manner that the first end of the threaded element 30 is located in a direction opposite the extending direction of the extensions 13, and the second end of the threaded element 30 is located in the extending direction of the extensions 13. The flange 33 of the threaded element 30 abuts against the abutting flange 23 of the insert 20.

The first extracting cap 40 is disposed in the insert 20 from the first openings 112, 21 of the handlebar body 10 and the insert 20 and abuts against the flange 33 of the threaded element 30.

The second extracting cap 50 includes a receiving groove 51 in one side thereof. The second extracting cap 50 is disposed in the insert 20 from the first openings 112, 21 of the handlebar body 10 and the insert 20 in such a manner that the first extracting cap 40 and the flange 33 of the threaded element 30 are received in the receiving groove 51 of the second extracting cap 50.

The plug 60 includes an inserting end 61 and a decorating end 62. The inserting end 61 of the plug 60 is inserted into the insert 20 from the first openings 112, 21 of the handlebar body 10 and the insert 20 and abuts against the second extracting cap 50 while the decorating end 62 covers the first opening 112 of the central portion 11 of the handlebar body 10. The decorating end 62 is tapered in a direction opposite the central portion 11 and shaped correspondingly to the central portion 11 of the handlebar body 10.

The stem 70 includes a screwing end 71 and a connecting end 72 that are arranged in a stepped manner. Between the screwing end 71 and the connecting end 72 is formed an end surface 73. The screwing end 71 is in the form of a rectangular cylinder and includes an inner threaded hole 711. The connecting end 72 includes a through hole 721 for engagement with a steerer tube of a front fork. The stem 70 further includes an operating through hole 74 penetrating the screwing end 71. The stem 70 is screwed on the threaded element 30 by inserting the screwing end 71 into the insert 20 in the assembling hole 111 of the handlebar body 10 from the second opening 22 of the insert 20 in the handlebar body 10 and then rotating the threaded element 30.

The aforementioned is the summary of the positional and structural relationship of the respective components of the second embodiment in accordance with the present invention.

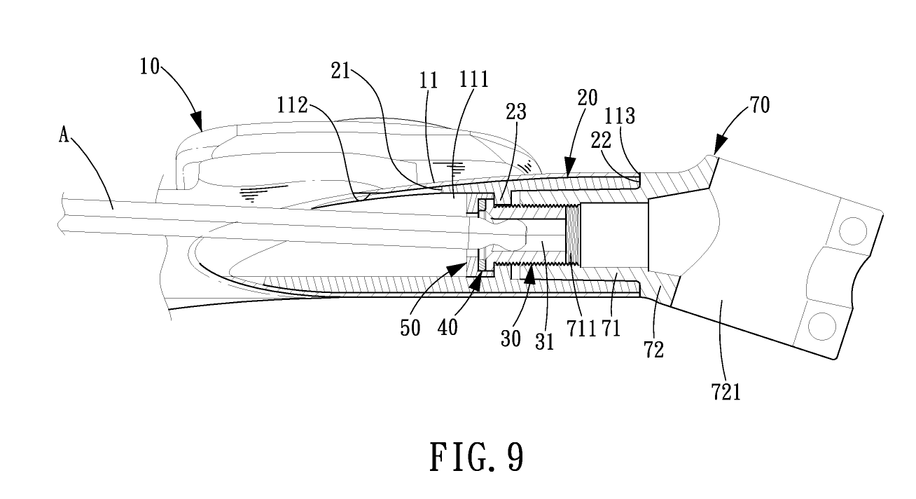

As shown in FIG. 5, the stem 70 is bonded to the steerer tube X1 of the front fork of the bicycle X. To assemble the handlebar body 10, the stem 70 is inserted into the insert 20 first, as shown in FIG. 9, and then the plug 60 is pulled away to open the first opening 112 of the handlebar body 10, so that the user can insert an operating tool A through the second extracting cap 50, the first extracting cap 40 and the threaded element 30 and into the insert 20 in the assembling hole 111. Then the user can fix the stem 70 to the handlebar body 10 by rotating the threaded element 30 with the operating tool A. And vice versa, rotating the threaded element 30 can also disassemble the stem 70 from the handlebar body 10 easily. To change the distance between the handlebar body and the rider, the stem 70 will be disassembled from the handlebar body 10 in the same method and replaced with a stem 70 having a different length.

Furthermore, after assembly, since the central portion 11 of the handlebar body 10 is sealed by the plug 60, which makes the handlebar body 10 tapered and streamlined, thus reducing the drag coefficient of the bicycle.

While we have shown and described various embodiments in accordance with the present invention, it is clear to those skilled in the art that further embodiments may be made without departing from the scope of the present invention.

What is claimed is:

1. A handlebar/stem attachment interface with minimal frontal area comprising:
a handlebar body including an central portion and two arms, the two arms having first ends thereof connected at both sides of the central portion, the central portion being formed with an assembling hole, the central portion being tapered;
a threaded element including a keyed hole, the threaded element being further formed with external threads on an outer surface of a first end thereof, the threaded element being inserted in the assembling hole of the handlebar body, and the first end of the threaded element being located in a direction opposite a tapered direction of the central portion; and
a stem including a screwing end and a connecting end, the screwing end including an inner threaded hole, the connecting end including a through hole for engagement with a steerer tube of a front fork, the stem further including an operating through hole penetrating the screwing end, the stem being screwed on the threaded element by inserting the screwing end in the assembling hole of the handlebar body.

2. The handlebar/stem attachment interface with minimal frontal area as claimed in claim 1, wherein two brake levers are provided at two second ends of the two arms, respectively, each of the two arms is provided with an abutting seat.

3. The handlebar/stem attachment interface with minimal frontal area as claimed in claim 1, wherein the assembling hole penetrates the handlebar body and includes a first opening open in the tapered direction of the central portion, and a second opening open in the direction opposite the tapered direction of the central portion.

4. The handlebar/stem attachment interface with minimal frontal area as claimed in claim 3 further comprising an insert, the insert being hollow and shaped correspondingly to the assembling hole, the insert including a first opening and a second opening in both ends thereof, the insert being inserted in the assembling hole of the handlebar body, the first opening of the insert is in communication with the first opening of the handlebar body while the second opening of the insert is in communication with the second opening of the handlebar body.

5. The handlebar/stem attachment interface with minimal frontal area as claimed in claim 4, the insert is further formed on an inner surface thereof with an abutting flange between the first opening and a second opening, a second end of the threaded element is formed with an outwards-extended flange, the threaded element is inserted into the insert in the assembling hole of the handlebar body in such a manner that the flange of the threaded element abuts against the abutting flange of the insert.

6. The handlebar/stem attachment interface with minimal frontal area as claimed in claim 5 further comprising a first extracting cap, the first extracting cap being disposed in the insert from the first openings of the handlebar body and the insert and abutting against the flange of the threaded element.

7. The handlebar/stem attachment interface with minimal frontal area as claimed in claim 1 further comprising a second extracting cap, the second extracting cap including a receiving groove in one side thereof and being disposed in the insert from the first openings of the handlebar body and the insert in such a manner that the first extracting cap and the flange of the threaded element are received in the receiving groove of the second extracting cap.

8. The handlebar/stem attachment interface with minimal frontal area as claimed in claim 7 further comprising a plug, the plug including an inserting end and a decorating end, the inserting end of the plug being inserted into the insert from the first openings of the handlebar body and the insert and then abutting against the second extracting cap while the decorating end covers the first opening of the central portion of the handlebar body, the decorating end being tapered in a direction opposite the central portion and shaped correspondingly to the central portion of the handlebar body.

9. The handlebar/stem attachment interface with minimal frontal area as claimed in claim 1 further comprising a first extracting cap, the threaded element is deposed in the assembling hole of the handlebar body after the first extracting cap is mounted on the threaded element.

10. The handlebar/stem attachment interface with minimal frontal area as claimed in claim 1, wherein the assembling hole in the central portion of the handlebar body includes a second opening open in a direction opposite a tapered direction of the central portion, a hollow insert is provided, the insert is shaped correspondingly to the assembling hole and includes a first opening and a second opening in both ends thereof, the insert is inserted in the assembling hole of the handlebar body, the second opening of the insert is in communication with the second opening of the handlebar body, the insert is formed on an inner surface thereof with an abutting flange between the first opening and a second opening thereof, the insert is further formed with an inner threaded hole extending from the abutting flange toward a direction opposite the second opening thereof, the threaded element consists of a first segment and a second segment that are connected to each other, the first segment and the second segment of the threaded element include a first outer threaded portion and a second outer threaded portion, respectively, the first outer threaded portion is screwed in the inner threaded hole of the stem while the second outer threaded portion is screwed in the inner threaded hole of the insert.

11. The handlebar/stem attachment interface with minimal frontal area as claimed in claim 10, wherein an outer diameter of the first segment of the threaded element is greater than that of the second segment of the threaded element, and a thread pitch of the first outer threaded portion is greater than a threaded pitch of the second outer threaded portion.
